(19) United States
(12) Patent Application Publication
(10) Pub. No.: US 2011/0253921 A1
(43) Pub. Date: Oct. 20, 2011

(54) NEEDLE VALVE ASSEMBLY WITH FLOATING SEAT APPARATUS

(75) Inventor: Steven Alan Jandl, Madison, WI (US)

(73) Assignee: GENERAL ELECTRIC COMPANY, Schenectady, NY (US)

(21) Appl. No.: 12/760,002

(22) Filed: Apr. 14, 2010

(51) Int. Cl. F16K 25/00

(52) U.S. Cl. 251/170

(57) ABSTRACT

A valve assembly includes a valve body defining a valve channel, and a floating seat defining a seat orifice in fluid communication with the valve channel. The valve assembly also includes a needle at least partially disposed within the valve channel. The floating seat is adapted to move relative to the valve body in a manner adapted to accommodate a misalignment between the needle and the floating seat.

### BACKGROUND OF THE INVENTION

The subject matter disclosed herein relates to a needle valve assembly having a floating seat apparatus.

Needle valve assemblies may be implemented to regulate a fluid flow rate. Conventional needle valve assemblies comprise a needle having tapered terminal end, and a seat defining an orifice. The tapered end of the needle is translatable into the orifice to occlude the orifice by a variable amount. In this manner, a user can translate the needle toward or away from the seat to regulate the rate of fluid flow through the orifice.

One problem with conventional needle valve assemblies is that they are sensitive to component misalignment. As an example, if the needle is too low relative to the seat, the needle will prematurely engage the lower edge of the seat orifice as the valve assembly is being closed. Additional translation of the needle will generate a force at the interface between the needle valve and seat, and the magnitude of this force will increase as the needle is translated further into the seat orifice. This force can diminish the precision with which the valve assembly regulates fluid flow, and may also cause the valve assembly to leak or prematurely fail.

### BRIEF DESCRIPTION OF THE INVENTION

The above-mentioned shortcomings, disadvantages and problems are addressed herein which will be understood by reading and understanding the following specification.

In an embodiment, a valve assembly including a valve body defining a valve channel, and a floating seat defining a seat orifice in fluid communication with the valve channel. The valve assembly also includes a needle at least partially disposed within the valve channel. The floating seat is adapted to move relative to the valve body in a manner adapted to accommodate a misalignment between the needle and the floating seat.

In another embodiment, a valve assembly includes a valve body defining a valve channel, and a floating seat disposed in contact with the valve body such that a slip interface is defined therebetween. The floating seat defines a seat orifice in fluid communication with the valve channel. The valve assembly also includes a spindle at least partially disposed within the valve channel. The spindle defines a needle at a terminal end portion. The needle is selectively translatable through the seat orifice to regulate a fluid flow through the valve channel. The floating seat is adapted to move relative to the spindle in a manner adapted to accommodate a misalignment between the needle and the floating seat.

In another embodiment, a system includes a manifold defining a valve assembly cavity, and a valve assembly disposed at least partially within the valve assembly cavity. The valve assembly includes a valve body defining a valve channel, and a floating seat disposed in contact with the valve body such that a slip interface is defined therebetween. The floating seat defines a seat orifice in fluid communication with the valve channel. The valve assembly also includes a spindle at least partially disposed within the valve channel. The spindle defines a needle at a terminal end portion. The needle is translatable at least partially through the seat orifice to regulate a fluid flow through the valve channel. The floating seat is adapted to move relative to the spindle in a manner adapted to accommodate a misalignment between the needle and the floating seat.

Various other features, objects, and advantages of the invention will be made apparent to those skilled in the art from the accompanying drawings and detailed description thereof.

### BRIEF DESCRIPTION OF THE DRAWINGS

FIG. 1 is a sectional representation of manifold and a valve assembly;

FIG. 2 is an exploded sectional representation of the valve assembly of FIG. 1;

FIG. 3 is a sectional representation depicting the valve assembly of FIG. 1 in a fully open position;

FIG. 4 is a sectional representation depicting the valve assembly of FIG. 1 in a partially open position; and

FIG. 5 is a sectional representation depicting the valve assembly of FIG. 1 in a fully occluded position.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

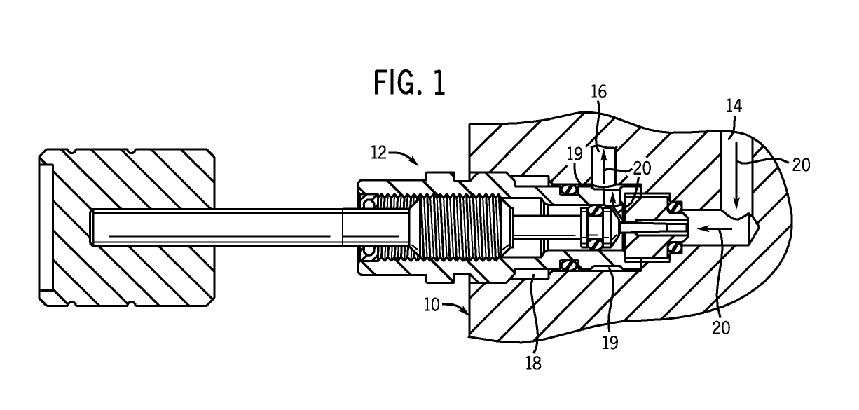

Referring to FIG. 1, a manifold 10 and valve assembly 12 are depicted in accordance with an embodiment. The manifold 10 and valve assembly 12 may be implemented to regulate the flow of a fluid. For purposes of this disclosure, the term “fluid” is defined to include a continuous, amorphous substance whose molecules move freely past one another and that has the tendency to assume the shape of its container. It should therefore be appreciated that the term “fluid” as previously defined may include a liquid or a gas. According to one embodiment, the manifold 10 and the valve assembly 12 are components of an anesthesia machine (not shown) and are implemented to regulate the flow of a gas (e.g., oxygen, nitrous oxide, or air) to a patient (not shown). Alternate implementations for the manifold 10 and/or the valve assembly 12 may be envisioned.

The manifold 10 defines an inlet passage 14, an outlet passage 16 and a valve assembly cavity 18. The valve assembly cavity 18 is adapted to retain the valve assembly 12. A portion of the valve assembly cavity 18 is adapted to receive fluid and will therefore be referred to a fluid cavity 19. The fluid cavity 19 is in direct fluid communication with the outlet passage, and may be selectively coupled with the inlet passage 14 via the valve assembly 12. Arrows 20 represent fluid flow through the inlet passage 14, through the valve assembly 12, through the fluid cavity 19, and through the outlet passage 16. As will be described in detail, the valve assembly 12 may be implemented to regulate the fluid flow represented by arrows 20.

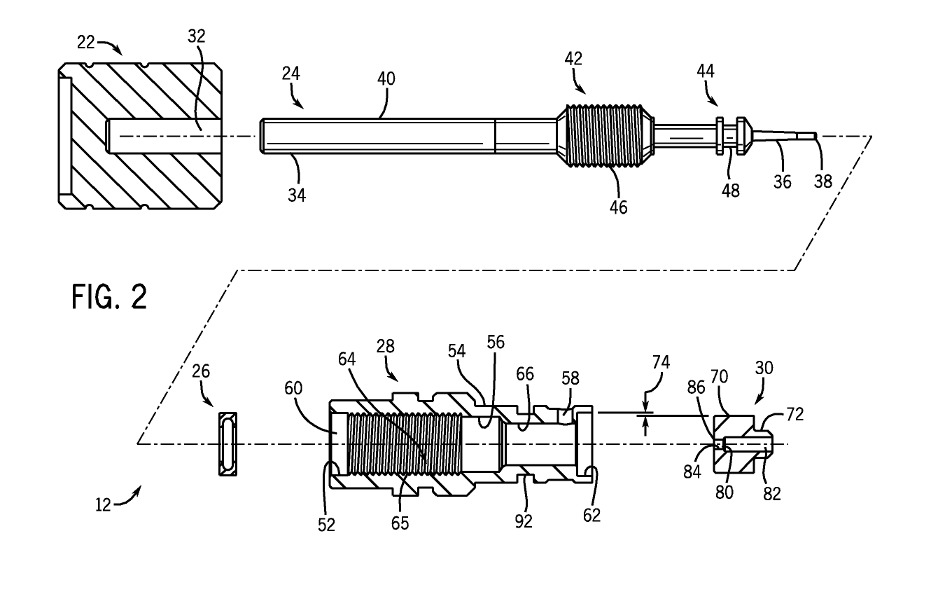

Referring to FIG. 2, an exploded sectional representation depicts the valve assembly 12 in accordance with an embodiment. According to the depicted embodiment, the valve assembly 12 includes a knob 22, a spindle 24, a bushing 26, a valve body 28 and a valve seat 30. The knob 22 defines a generally cylindrical internal channel 32 adapted to retain the spindle 24. The knob 22 is an optional component that may be incorporated to provide a mechanical advantage and thereby facilitate the rotation of the spindle 24 in a precise manner.

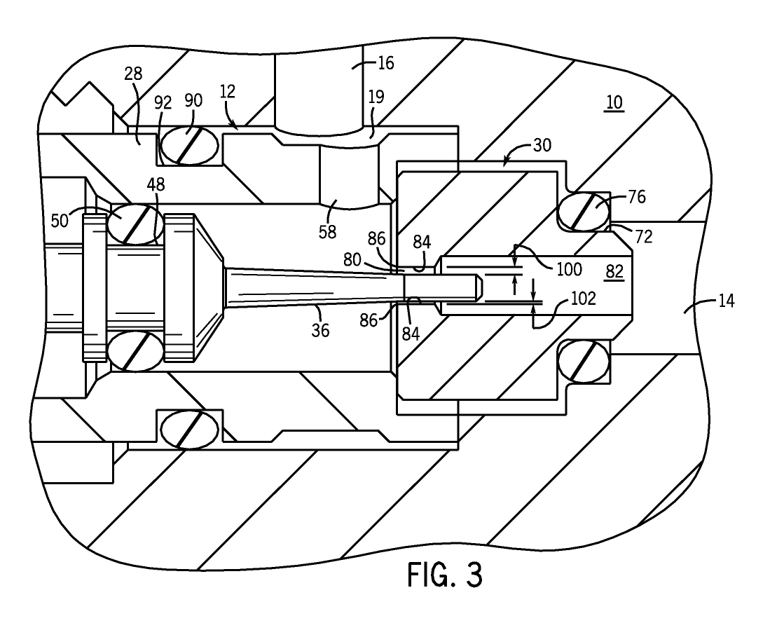

The spindle 24 defines a terminal end portion 34 and a generally opposite terminal end portion 36. The end portion 34 may be secured within the internal channel 32 of the knob 22. The end portion 36 tapers to a point 38 and may therefore also be referred to as the needle 36. The spindle 24 comprises a generally cylindrical body 40 having a first increased diameter portion 42, and a second increased diameter portion 44. The first increased diameter portion 42 defines external spindle metering threads 46 adapted to convert spindle rotation into translation. The second increased diameter portion 44 defines an o-ring groove 48 adapted to accommodate an o-ring 50 (shown in FIG. 3). As will be described in detail hereinafter, the O-ring 50 is configured to form a seal between the spindle 24 and the valve body 28.

The bushing 26 is generally annular, and is configured to support and align the spindle 24 within the valve body 28 in a manner that allows for spindle 24 rotation. The bushing 26 is configured to receive the spindle 24, and may be retained within a bushing groove 52 of the valve body 28 as will be described in detail hereinafter. Accordingly, the outer diameter of the bushing 26 is slightly greater than the inner diameter of the busing groove 52, and the inner diameter of the bushing 26 is slightly greater than the outer diameter of the spindle body 40. The bushing 26 may comprise a durable, low friction material. According to one embodiment, the bushing 26 is press-fit into the bushing groove 52 such that the bushing 26 remains fixed relative to the valve body 28. Spindle 24 rotation may be facilitated with a lubricant (not shown) disposed at the interface between the spindle 24 and the bushing 26, or with a low friction bushing sleeve (not shown).

The valve body 28 is generally hollow, and comprises an external surface 54, an internal surface 56 and fluid flow port 58. At least a portion of the external surface 54 of the valve body 28 is in contact with the manifold 10 (shown in FIG. 1) for purposes of retaining the valve body 28 within the valve assembly cavity 18 (shown in FIG. 1). The external surface 54 defines an o-ring groove 92 adapted to retain an o-ring 90 (shown in FIG. 3). The o-ring 90 is configured to form a seal between the valve body 28 and the manifold 10 (shown in FIG. 1).

The internal surface 56 defines a variable diameter internal valve channel 60. The internal surface 56 terminates at one end with the bushing groove 52, and terminates at an opposite end with a seat groove 62. The bushing groove 52 is adapted to retain the bushing 26, and the seat groove 62 is adapted to receive the seat 30. The internal surface 56 of the valve body 28 comprises a threaded section 64 defining internal valve metering threads 65, and a sealing surface 66. The valve metering threads 65 are adapted to engage the spindle metering threads 46 when the spindle 24 is disposed within the valve channel 60. The port 58 is in fluid communication with the valve channel 60.

The valve seat 30 is also referred to as the floating seat 30 because it is configured to move (e.g., translate and/or rotate) relative to the spindle 24 and the valve body 28 in order to accommodate component misalignment. The valve seat 30 defines a terminal end portion 70 and a generally opposite terminal end portion 72. The terminal end portion 70 is generally cylindrical and is disposed within the seat groove 62. There is a radial design clearance or gap 74 between the seat groove 62 and the end portion 70 to allow for valve seat 30 motion. The terminal end portion 72 is adapted to receive an o-ring 76 (shown in FIG. 3). The o-ring 76 is configured to form a seal between the valve seat 30 and the manifold 10 (shown in FIG. 1). The valve seat 30 also defines an orifice 80 near terminal end 70, and an internal channel 82 in fluid communication with the orifice 80. The orifice 80 is more precisely defined by an annular surface 84 having an external edge 86.

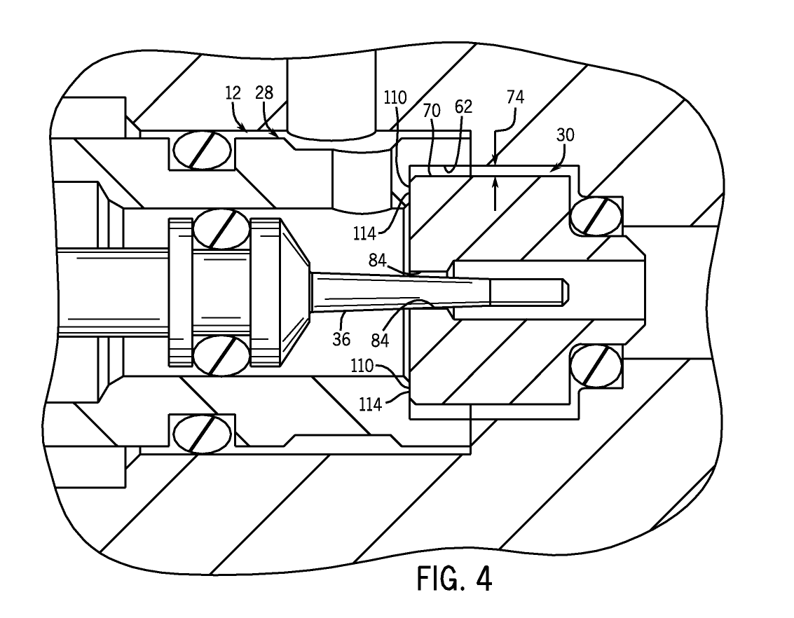

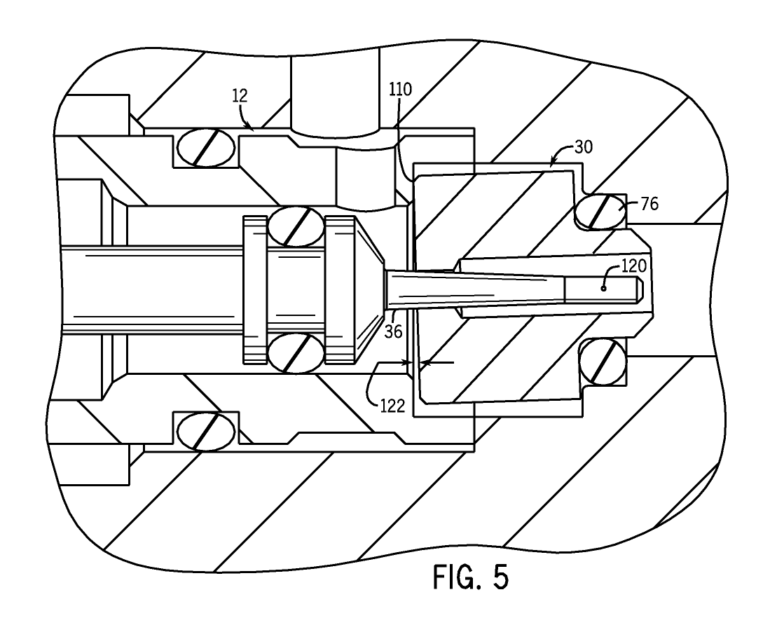

Having described the components of the manifold 10 and valve assembly 12, their operation will now be explained in accordance with an embodiment. FIGS. 3-5 depict a sequence of events during which the valve assembly 12 is operated through its full range of motion from fully open in FIG. 3, to partially open in FIG. 4 and to fully occluded in FIG. 5. For purposes of illustrating the operation of the valve assembly 12, the needle 36 and the seat 30 are shown as being axially misaligned such that the needle 36 is low relative to the seat 30. It should be appreciated that, while many valve assemblies are produced with minimal misalignment, it is not uncommon for component manufacturing tolerances and build variation to yield significant misalignment. It is well known that such misalignment can contribute to premature wear, component failure, and operational imprecision.

Referring to FIG. 3, the valve assembly 12 is shown in its fully open position. In this position, fluid is able to flow at a maximum rate through the internal channel 82, the orifice 80, the port 58, the fluid cavity 19, and the manifold outlet passage 16. The o-ring 76 disposed on the terminal end portion 72 of seat 30 may be implemented to prevent fluid from passing between the seat 30 and the manifold 10, and to thereby direct any fluid flow into internal channel 82. The o-ring 50 disposed within the spindle o-ring groove 48 may be implemented to prevent fluid from passing between the spindle 24 and the valve body 28, and to thereby direct such fluid flow into the port 58. The o-ring 90 disposed within the valve body o-ring groove 92 may be implemented to prevent fluid flow from passing between the valve body 28 and the manifold 10, and to thereby direct such fluid flow into the manifold outlet passage 16.

The valve assembly 12 is depicted as having a needle 36 that is misaligned relative to the seat 30. More precisely, the misalignment is depicted as comprising a needle 36 that is low relative to the seat 30. This misalignment renders the gap 100 defined between the needle 36 and the top portion of the annular surface 84 greater than the gap 102 defined between the needle 36 and the bottom portion of the annular surface 84.

Referring to FIG. 4, the valve assembly 12 is shown in a partially open position at which the previously described component misalignment has caused the needle 36 to prematurely engage the bottom portion of the annular surface 84. In a more conventional design wherein the valve seat is fixed relative to the valve body, any additional translation of the needle 36 through the orifice 80 could generate a force at the point of contact. This generated force could damage the needle 36 and/or the seat 30 thereby impairing valve assembly 12 durability. In an effort to maintain optimal durability, the seat 30 is configured to move in a manner adapted to accommodate component misalignment. For purposes of this disclosure, reference to a valve seat “configured to move in a manner adapted to accommodate component misaligmnent” should be defined to include valve seat translation and/or rotation having the effect of diminishing the magnitude of the force generated by a misaligned needle as it initially engages and thereafter continues to pass through a seat orifice.

Seat 30 motion is facilitated by providing the radial design clearance 74 between the seat groove 62 and the seat end portion 70. Additionally, a slip interface 110 defined at the contact surface between the seat 30 and the valve body 28 is configured to facilitate relative motion or slip between the respective components. Relative motion may be facilitated by selecting a component material having a relatively low coefficient of friction, or through the application of a lubricant 114 disposed at the slip interface 110. When the seat 30 is in the steady state position depicted in FIG. 4, the slip interface 110 between the seat 30 and valve body 28 defines a generally annular contact surface. According to an alternate embodiment (not shown), the slip interface may define a semi-spherical contact surface such that the seat can pivot relative to the valve body while retaining generally consistent interface engagement.

Referring to FIG. 5, the valve assembly 12 is shown in its fully occluded position at which no fluid can pass through the seat orifice 80. It can be seen that the seat 30 has moved to accommodate misalignment with the needle 36. Seat 30 motion has been exaggerated for purposes of more clearly illustrating the operation of the valve assembly 12. Seat 30 motion has been depicted as primarily comprising counter-clockwise rotation about an imaginary point 120 to accommodate a specific type of misalignment (i.e., a needle that is low relative to the valve seat). It should be appreciated, however, that the seat 30 can translate and/or rotate in a variety of different manners to most effectively accommodate relative needle 36 misalignment in a direction defined by any of the 360 degrees or freedom. By translating and/or rotating in the manner described, the seat 30 is able to at least partially absorb the force generated by a misaligned needle as it passes further through the seat, and to realign with the needle such that the needle is more centered within the seat aperture. This absorption and realignment eliminates or diminishes the magnitude of the force applied to the needle 36 and the seat 30, and thereby improves valve assembly 12 durability.

When the seat 30 has been rotated in the manner depicted in FIG. 5, the slip interface 110 between the seat 30 and valve body 28 defines an arcuate contact region or, in the most extreme case, a point contact disposed at the top of seat 30. The bottom of the seat 30 has been rotated away and is no longer in contact with the valve body 28 such that a gap or separation 122 is defined therebetween. It should also be appreciated that translation and/or rotation of the seat 30 tends to compress the o-ring 76. The o-ring 76 is therefore preferably composed of an elastomer that may be repeatedly compressed and expanded without experiencing permanent deformation. As the needle 36 is retracted to open the valve assembly 12, the o-ring 76 will expand and thereby apply a force tending to return the seat 30 to the steady state position shown in FIGS. 3-4.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I claim:

1. A valve assembly comprising:
a valve body defining a valve channel;
a floating seat defining a seat orifice in fluid communication with the valve channel; and
a needle at least partially disposed within the valve channel;
wherein the floating seat is adapted to move relative to the valve body in a manner adapted to accommodate a misalignment between the needle and the floating seat.

2. The valve assembly of claim 1, wherein the floating seat is disposed in contact with the valve body such that a slip interface is defined therebetween, said slip interface configured to enable relative motion between the floating seat and the valve body.

3. The valve assembly of claim 1, further comprising a lubrication disposed at the slip interface.

4. The valve assembly of claim 1, wherein the valve body defines a seat groove adapted to receive the floating seat, and wherein the seat groove is dimensioned to provide a radial design clearance between the valve body and the floating seat in order to accommodate said floating seat movement.

5. The valve assembly of claim 1, further comprising an o-ring disposed about the periphery of the floating seat, said O-ring being configured to elastically deform in a manner adapted to accommodate said floating seat movement.

6. The valve assembly of claim 1, wherein the o-ring is composed of an elastomer.

7. The valve assembly of claim 1, wherein the needle is selectively translatable through the seat orifice to regulate a fluid flow

8. The valve assembly of claim 1, wherein the floating seat is adapted to move relative to the valve body in a manner tending to center the needle within the seat orifice.

9. A valve assembly comprising:
a valve body defining a valve channel;
a floating seat disposed in contact with the valve body such that a slip interface is defined therebetween, said floating seat defining a seat orifice in fluid communication with the valve channel; and
a spindle at least partially disposed within the valve channel, the spindle defining a needle at a terminal end portion, the needle being selectively translatable through the seat orifice to regulate a fluid flow through the valve channel;
wherein the floating seat is adapted to move relative to the spindle in a manner adapted to accommodate a misalignment between the needle and the floating seat.

10. The valve assembly of claim 9, further comprising a lubrication disposed at the slip interface.

11. The valve assembly of claim 9, wherein the valve body defines a seat groove adapted to receive the floating seat, and wherein the seat groove is dimensioned to provide a radial design clearance between the valve body and the floating seat in order to accommodate said floating seat movement.

12. The valve assembly of claim 9, further comprising an o-ring disposed about the periphery of the floating seat, said O-ring being configured to elastically deform in a manner adapted to accommodate said floating seat movement.

13. The valve assembly of claim 9, wherein the floating seat is adapted to move relative to the spindle in a manner tending to center the needle within the seat orifice.

14. A system comprising:
a manifold defining a valve assembly cavity; and
a valve assembly disposed at least partially within the valve assembly cavity, said valve assembly comprising:
a valve body defining a valve channel;
a floating seat disposed in contact with the valve body such that a slip interface is defined therebetween, said floating seat defining a seat orifice in fluid communication with the valve channel; and
a spindle at least partially disposed within the valve channel, the spindle defining a needle at a terminal end portion, the needle being translatable at least partially through the seat orifice to regulate a fluid flow through the valve channel;
wherein the floating seat is adapted to move relative to the spindle in a manner adapted to accommodate a misalignment between the needle and the floating seat.

15. The system of claim 14, further comprising a lubrication disposed at the slip interface.

16. The system of claim 14, wherein the valve body defines a seat groove adapted to receive the floating seat, and wherein the seat groove is dimensioned to provide a radial design clearance between the valve body and the floating seat in order to accommodate said floating seat movement.

17. The system of claim 14, further comprising an o-ring disposed about the periphery of the floating seat, said o-ring being configured to elastically deform in a manner adapted to accommodate said floating seat movement.

18. The system of claim 14, wherein the floating seat is adapted to move relative to the spindle in a manner tending to center the needle within the seat orifice.
